(19) United States
(12) Patent Application Publication
(10) Pub. No.: US 2004/0071838 A1
(43) Pub. Date: Apr. 15, 2004

(54) Quadrate container for refrigerated and frozen dough intermediates

(76) Inventor: David A. Kirk, Coon Rapids, MN (US)

Correspondence Address: GENERAL MILLS, INC., P.O. BOX 1113, MINNEAPOLIS, MN, 55440, US

(21) Appl. No.: 10/269,183

(22) Filed: Oct. 11, 2002

(51) Int. Cl. A23B 4/00

(52) U.S. Cl. 426/120

(57) ABSTRACT

The present invention relates to a multiple part, quadrate container used for refrigerated and frozen dough intermediates that provides portion control for the consumer. More particularly, the present invention is a paperboard container sized and configured to receive one or more individual dough intermediates containing packages. The dough intermediates are contained or packaged in envelopes, sleeves, tube, cans or films that may include the ability to sequester or scavenge gas released by the dough. By incorporating a package within a package, a portion control arrangement is provided that gives the consumer added convenience.

### CROSS-REFERENCES TO RELATED APPLICATIONS

None.

### FIELD OF THE INVENTION

The present invention relates to a multiple part, quadrate container used for refrigerated and frozen dough intermediates that provides portion control for the consumer. More particularly, the present invention provides an external paperboard container sized and configured to receive one or more individual dough intermediates containing packages. The dough intermediates are contained or packaged in envelopes, sleeves, tube, cans or films that may include the ability to sequester or scavenge gas released by the dough. By incorporating a package within a package, a portion controlled structure is provided giving additional convenience to the consumer.

### BACKGROUND OF THE INVENTION

Dough packaging can be quite expensive and even complex in that the package has to be able to withstand the pressures of the gases that build up from raw or uncooked dough. The amount of gases that can build up in the dough are dependent upon a number of conditions including the type and amount of yeast used in the dough, the temperature at which the dough is stored and the like. The resulting pressure of the gas build up can be significant and can even cause small explosions of the containers in which the dough is stored. As such, packing of dough intermediates or raw dough has been generally focused on containers that can withstand a significant amount of pressure and are airtight.

One of the preferable current packaging arrangements has taken the form of cans, which in addition to being more expensive than other packages are also significantly more complicated to produce, pack, ship and even use. In addition to the problems of potential explosion caused by the build up of gas in the can, the gas build up may contribute to other undesirable circumstances which may cause the can to become disfigured. That is, the gas accumulation causes the can to bubble or swell up, which is unappealing to consumers and creates difficulties for the retailer as the cans become difficult, if not impossible to stack. This situation often results in the can then being returned to the manufacturer which obviously creates a significant expense. If a recurring problem, the relationship with the retailer can become strained and the customer disenfranchised with product offering.

Dough packaging can also experience a problem known as syruping in which liquid from the dough seeps or wicks out through the dough can which can create a sticky mess on the exterior of the packaging, making the product unsaleable.

Another drawback with dough cans is that they can be confusing and even difficult to open. Current packaging requires the user to peel away an outer liner and then attempt to split the can along one of the exposed seems. If the die used in the fabrication of the can has not completely cut through the material to form the seem, then the can may not open causing the user to rely on a knife or other utensil to free the dough from the can this situation may create unnecessary hazards to the user. Alternatively, when pressure has built up in the can, the can may burst open unexpectedly after the user has removed the outer liner, thus startling the consumer. In the former situation, the consumer is frustrated with the difficulty in opening the product and in the latter, the consumer is leery about opening another canned dough product.

Other packaging for raw dough or dough intermediates has included plastic films or tubes for products such as cookie dough and the like. Here, the plastic film is applied directly to the cookie dough log as the cookie dough log is extruded from the forming apparatus. The ends of the plastic tubes are then crimped and banded to seal the container. While plastic films overcome some of the drawbacks that cans suffer from, such as the film can accommodate a limited expansion due to gas build up and is relatively inexpensive, the films are not suitable for all raw dough applications and packaging requirements or completely overcome all of the previous drawbacks. The plastic films can also burst if the gas build up is excessive. The gas build up can also cause the crimped ends to become undone thus exposing the dough to the atmosphere and contamination. Unfortunately, the crimped ends of the tubes also create wasted product in that the ends of the dough log have a crinkled or pinched appearance, which is aesthetically unappealing, leading the consumer to discard the material found in the respective ends.

In addition, the use of tubes is not acceptable from a customer prospective for such things as biscuits, rolls, buns, pastries, bread sticks and the like as the pressure of the tube has a tendency to compact or crush the dough products before they are frozen or the tubes do not provide sufficient support to the intermediates. That is, an extruded rope of cookie dough creates a relatively rigid supporting structure for filling a plastic tube as the density of the dough is relatively rigid. However, if one put biscuits or rolls in a tube, the tube would likely be flaccid or flimsy and cause handling difficulties.

Paperboard containers have been used in a number of packaging applications, including in the packaging of materials that release gas while in the package, such as coffee and fruits and vegetables. U.S. Pat. No. 6,451,423 discloses one such example and describes the use of a polymeric matrix, which may be coated or laminated onto a paperboard as well as other substrates.

In each of the foregoing examples, the consumer is required to either use the entire contents of the package or in the alternative, use only that portion of the package that is required and then repackage the remaining portion of the product for use at a later time. As home produced packaging is not as effective as packaging provided by the manufacturer, the remaining product will likely stale over time, causing it to be discarded.

However, heretofore multiple part convenient to use, portion controlled containers, whether coated with a substance or not, have not been used in the packaging of refrigerated and frozen raw dough or dough intermediates. This may be due to the fact that refrigerated and frozen dough products are stored in refrigerators or freezers and moisture generally builds up due to condensation caused by the regular opening and closing of the appliances.

What is needed therefore is a portion controlled packaging arrangement for refrigerated and frozen raw dough that is convenient to use and overcomes the drawbacks of the foregoing arrangements.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

In one preferred embodiment of the present invention a quadrate container for refrigerated and frozen doughs is described and includes a generally planar element for enclosing a packaged dough intermediate. The generally planar element has first and second side edges and first and second ends. The first and second ends being substantially parallel to one another and substantially perpendicular to the first and second sides and the generally planar element has first and second faces.

The generally planar element has at least first, second and third lines of weakness disposed in the generally planar element and substantially parallel to the first and second sides. First and second fold lines are provided and formed in the generally planar element and run longitudinally of the generally planar element and parallel to one another, and spaced from the first and second ends. A sealing flap is provided adjacent one of the first and second sides and substantially parallel to one of the first and second sides for holding the generally planar element in a folded configuration.

First, second, third and fourth panels are provided in the generally planar element and are disposed between the first and second sides. The first panel is defined by the area between one of the first and second sides and the first line of weakness. The second panel is defined by the area between the first line of weakness and the second line of weakness. The third panel is defined by the area between the second line of weakness and the third line of weakness. The fourth panel is defined by the area between the third line of weakness and one of the first and second sides.

The quadrate container of the present invention is provided with at least one preformed container that is sized and configured to hold the dough intermediate and sized and configured to fit within the generally planar element when in said folded configuration to create a portion controlled container for refrigerated and frozen doughs.

Other embodiments of the present invention include the use of additional preformed containers that can fit within the quadrate container when folded. Such other containers include alternate raw dough intermediate containers, such as dough cans, envelopes, tubes and sleeves as well as containers for sauces, spreads, dips and the combinations thereof.

A further embodiment of the present invention relates to a multiple part container for use with refrigerated and frozen dough. The multiple part container includes a first container having a first internal volume and constructed of a first material and at at least a second container having a second internal volume and constructed of a second material distinct from the first material. The second internal volume is less than the first internal volume and the second container is sized and configured to fit within the first container. The second container is sized and configured to receive at least one dough intermediate to create a portion controlled container for refrigerated and frozen doughs.

Additional embodiments include the use of a third container disposed within the first container. The third container can have similar or equivalent dimensions with that of the second container or the third container can have an internal volume that is distinct from each of the first and second containers. In addition, the third container can be used for dough intermediates or other items such as dips, spreads, sauces and combinations or the like.

These and other objects of the invention will become clear from an inspection of the detailed description of the invention and from the appended claims.

Publications, patents and patent applications are referred to throughout this disclosure. All references cited herein are hereby incorporated by reference.

There are a number of permutations possible for each of the foregoing embodiments and one with skill in the art would readily recognize such variations.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a front view of the generally planar element which when folded forms the quadrate container of the present invention;

FIG. 2 illustrates the back or second face of the generally planar element which when folded forms the quadrate container of the present invention;

FIG. 3 shows a front elevation of an unfilled quadrate container after the generally planar element has been assembled into its folded configuration;

FIG. 4 illustrates one embodiment of a preformed container suitable for holding the raw dough or dough intermediate which is sized and configured to fit within the quadrate container after the generally planar element has been assembled into is folded configuration;

FIG. 4A provides a further illustration of a cut away of an additional internal or second container to fit within the first quadrate container;

FIG. 5 illustrates the quadrate container of the present invention having a number of preformed containers positioned internally of the quadrate container and visible though a cut out in the generally planar element to demonstrate the portion control feature of the present invention;

FIG. 6 is a view of an alternate assembly of the quadrate container in which no cutout is provided;

FIG. 7 is an end view of the quadrate container showing various preformed dough intermediate containers disposed therein.

### DETAILED DESCRIPTION OF THE INVENTION

The present invention is now illustrated in greater detail by way of the following detailed description, but it should be understood that the present invention is not to be construed as being limited thereto.

The present invention is a novel, multiple part, portion controlled container for refrigerated and frozen raw dough or dough intermediates for use in retail and wholesale establishments. The container of the present invention provides convenience and simplicity for the user as well as potentially economic advantages to the manufacturer.

As used herein the term “dough intermediate” or “dough intermediates” refers to a dough that is required to undergo one or more treatment steps, such as baking, cooking, frying or the like before the dough is ready for human or animal consumption. The intermediate is generally in an uncooked or raw form.

As used herein the term “portion control” refers to the ability to select variable serving sizes of the product.

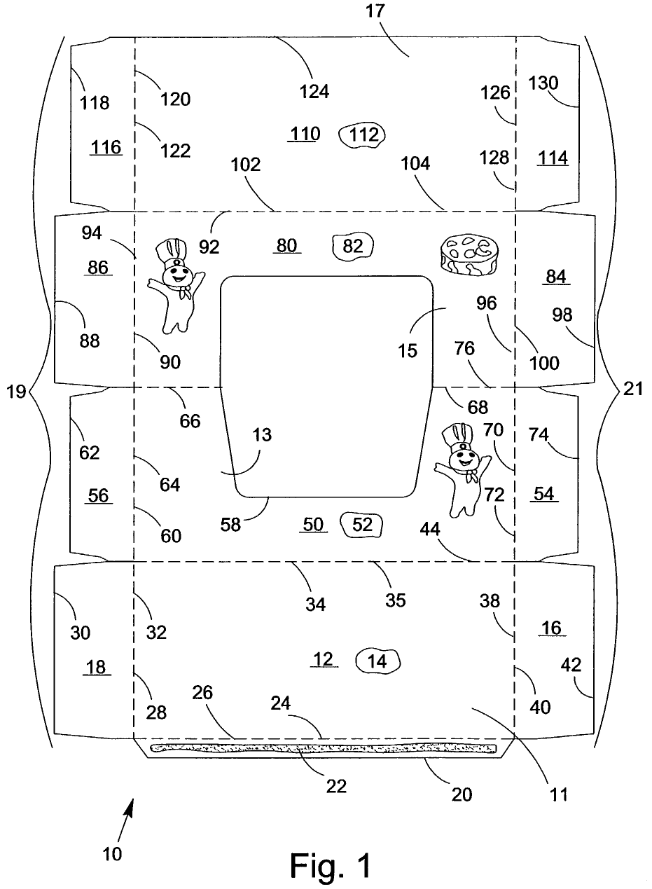

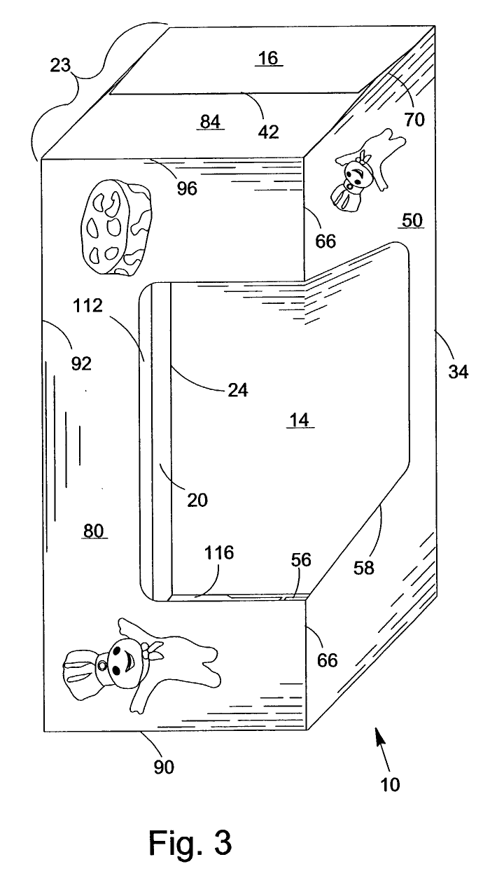

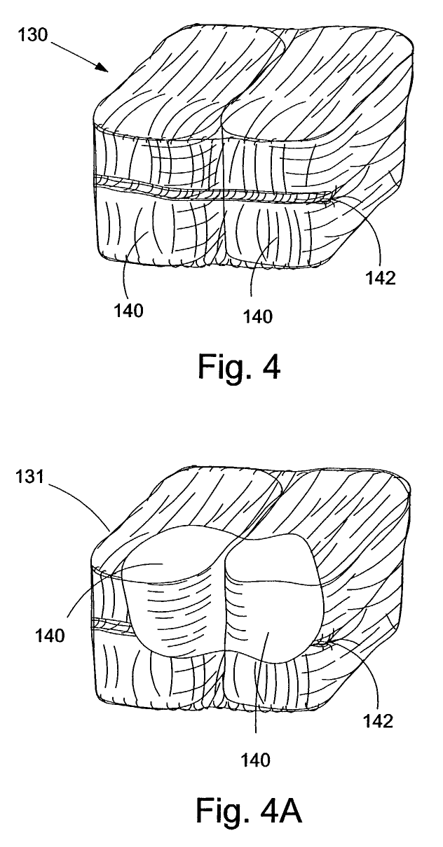

Turning now to FIG. 1, the generally planar element is depicted by reference numeral 10. The generally planar element 10 has a first panel 1, second panel 13, third panel 15 and fourth panel 17. The first panel 11 has first and second faces 12 and 14, respectively. The first panel 11 is provided with end flaps 16 and 18, which extend from the longitudinally extending end edges 28 and 38 of the first panel 11. First panel 11 is also provided with a sealing flap 20, which is connected to the first panel 11 along transversely extending side edge 24. The sealing flap 20 is provided with a sealing means 22, such as a line of adhesive, so as to seal the generally planar element 10 in its folded configuration (see FIGS. 3 and 4). The sealing flap 20 is moveable about a line of weakness 26 so that it can be brought into sealing engagement with fourth panel 17. A suitable adhesive may include a hot melt, permanent adhesive, or a pressure sensitive permanent adhesive, which seals without the application of heat, or a cold glue.

The end flaps 16 and 18 are foldable about lines of weakness 40 and 32 so as to form part of the end closure of the generally planar element when assembled into is final folded configuration. End flap 16 is provided with a longitudinally extending end edge 42 and end flap 18 is provided with a longitudinally extending end edge 30.

The first panel 11 is thus defined by the area including the longitudinally extending ends 28 and 38 and transversely extending sides 26 and 34. The area of first panel 11 also includes the area of first and second end tabs 16 and 18 thus pushing out the longitudinally extending sides to end edge 30 and 42 or portions of the total sides of the generally planar element 10 illustrated by reference numerals 19 and 21.

The first panel 11 is connected to second panel 13 along transversely extending side edge 34. The first panel 11 is foldable about a line of weakness 35 such that it may be folded into a relatively perpendicular configuration to that of the second panel 13.

Second panel 13 has first and second faces 50 and 52 and first and second end flaps 54 and 56. The second panel 13 is connected to the first panel 11 along transversely extending side edge 34 and foldable about line of weakness 44.

End edge 56 is connected to second panel 13 along longitudinally extending end edge 60 and foldable about a longitudinally extending line of weakness 64. End flap 56 has a longitudinally extending end edge 62, which forms a portion of the end closure when the generally planar element 10 is assembled into its folded configuration. End flap 54 which is transversely opposite end flap 56 and is connected to second panel 13 along longitudinally extending side edge 70. The end flap 54 is folded along longitudinally extending line of weakness 72 to aid in the formation of the end closure when the generally planar element 10 is assembled into is folded configuration.

The area of the second panel 13 is defined by transversely extending sides 60 and 66 and longitudinally extending ends 60 and 70. The area of the second panel 13, may also include first and second end tabs 54 and 56 and hence the respective longitudinally extending edges 62 and 74 as well as portions of the total ends of the generally planar element 10 illustrated by reference numerals 19 and 21.

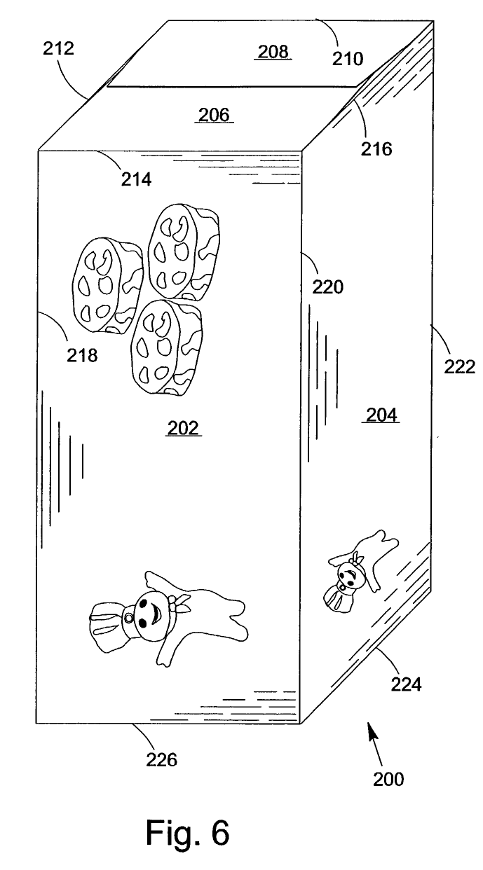

The second panel 13 is connected to the third panel 15 along transversely extending side edge 66 and is foldable about a transversely extending line of weakness 68. As illustrated in FIG. 1, the second and third panels 13 and 15 respectively, are provided with a cut out area designated by reference numeral 58. The cut out 58 is provided so that a prospective consumer can view the internal contents of the generally planar element 10 when in its folded configuration. It should however be understood, that the cut out 58 may be in only one panel or may extend into two, three or even all four panels of the present invention, depending on the particular configuration required by the manufacturer. Alternatively, no cut out may be provided in the configuration (see FIG. 6).

The third panel 15 has first and second faces 80 and 82, respectively, and is connected to the second panel 13 along a transversely extending side edge 76. The third panel 15 is provided with first and second end tabs 84 and 86. End tab 86 is connected to the third panel 15 along longitudinally extending edge 90 and foldable about a longitudinally extending line of weakness 94. End tab 86 has a longitudinally extending end edge 88 that runs parallel to the longitudinally extending line of weakness 94 and longitudinally extending end edge 90.

The other end tab 84 is connected to the third panel 15 along longitudinally extending line of weakness 100, which is coterminous with a side edge 96 of the third panel 15. Second longitudinally extending side edge 98 of tab 84 is parallel to the longitudinally extending line of weakness 100.

The area of the third panel 15 is thus defined by transversely extending sides 76 and 92 and longitudinally extending ends 90 and 96. In addition, the area of the third panel 17 may also include the area of the tabs 84 and 86 thereby extending to the longitudinally extending ends 88 and 98 of the tabs 84 and 86 as well as portions of the total ends of the generally planar element 10 illustrated by reference numerals 19 and 21.

The third panel 15 is connected to fourth panel 17 along a transversely extending side 92 and foldable about a transversely extending line of weakness 102 such that third panel 15, when moved into position, is in a perpendicular position to both fourth panel 17 and second panel 13, but parallel with first panel 11.

Fourth panel 17 is connected to the third panel along transversely extending side edge 104 and has first and second faces 110 and 112 respectively. The fourth panel 17 also has two end tabs 114 and 116, which are transversely opposed to one another. End tab 116 is connected to the fourth panel 17 along a longitudinally extending line of weakness 120 on a first side and has a second side 118 defining the area of the tab 116. The other tab 114 is connected to the fourth panel 17 along a longitudinally extending line of weakness 126 along a first side and has a second side end 130 offset from the first side in the transverse direction, and running parallel thereto.

The fourth panel 17 is defined by transversely extending sides 104 and 124 and longitudinally extending first and second ends 122 and 128. The fourth panel 17 may also include the area of end tabs 114 and 116 as well as portions of the total ends of the generally planar element 10 illustrated by reference numerals 19 and 21.

Transversely extending lines of weakness 35, 68 and 102 form the first, second and third lines of weakness and are generally disposed parallel to one another. A fourth line of weakness 24 is also disposed parallel to the first, second and third lines of weakness 35, 68 and 102 and is used where a sealing flap 20 is employed to complete the enclosure of the folded configuration as shown in FIGS. 3 and 4. The lines of weakness 35, 68 and 102 run parallel to the first and second sides 26 and 124 of the generally planar element 10.

Two generally parallel longitudinally extending lines of weakness are disposed in the generally planar element 10. The first fold line is comprised of longitudinally extending fold lines 32, 64, 94 and 120 and spaced inwardly of a first side edge generally depicted by reference numeral 19. The second fold line is comprised of longitudinally extending fold line 40, 72, 100 and 126 and is spaced inwardly of second side edge depicted generally by reference to numeral 21.

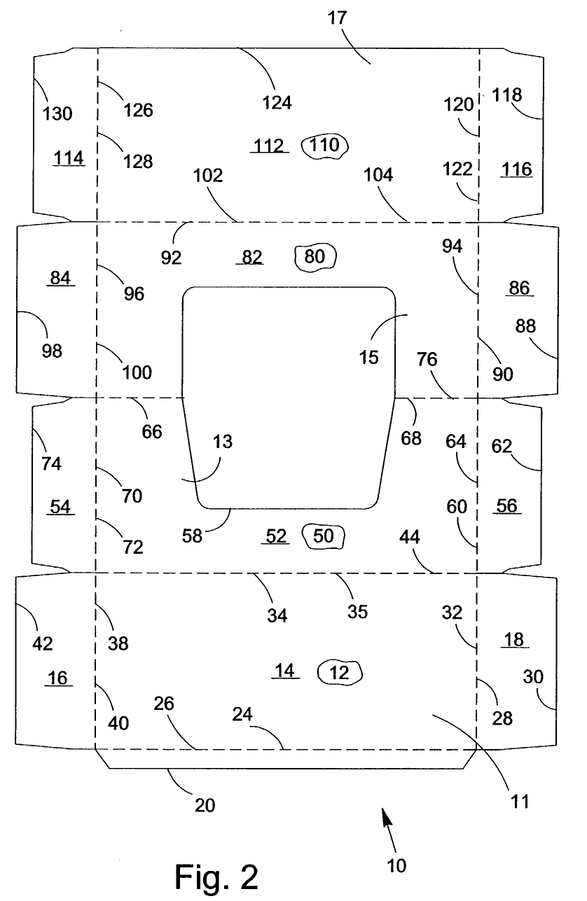

Turning now to FIG. 2, the second face 14, 52, 82 and 112 of each of the first 11, second 13, third 15 and fourth 17 panels are illustrated showing the reverse side of the generally planar element 10.

In one folding embodiment of the present invention for the generally planar element 10, the final folded configuration of which is illustrated in FIG. 3, the fourth panel 17 is folded about transversely extending line of weakness 102 so that it is generally perpendicular to third panel 15. The third panel 15 is folded about transversely extending line of weakness 68 so that the third panel is disposed generally perpendicularly to the second panel 13 and the fourth panel 17 is now in a parallel arrangement with the second panel 13, forming a “C” shaped configuration. Finally, the first panel 11 is folded about transversely extending line of weakness 35 so that the first panel 11 is disposed generally perpendicularly to second panel 13 and in a parallel arrangement with third panel 15. Then, sealing flap 20 is folded about transversely extending line of weakness 26 so as to contact the second face 112 of the fourth panel 17 to create a sealing engagement and close panels 11, 13, 15 and 17 into a generally rectangular configuration as seen in FIG. 3.

Next, end tabs 54 and 56 of second panel 13 and end tabs 114 and 116 of fourth panel 17 are folded inwardly (towards the interior of the rectangle formed above) about longitudinally extending lines of weakness 64, 72, 120 and 126, respectively so that they are generally perpendicular to the panels 13 and 17 from which they originate. Then, end tabs 16 and 18 and 84 and 86 are folded inwardly (as discussed above) about longitudinally extending lines of weakness 40, 32 and 100 and 90, respectively so that they are generally perpendicular to the panels 11 and 15 from which the tabs extend. Thus, tabs 16, 18, 84 and 86 are disposed in an interlocking relationship with tabs 54, 56, 114 and 116 to form and end closure 23 of the carton as shown in FIG. 3.

FIG. 3 illustrates the quadrate container 10 of the present invention in its folded configuration. The container 10 is provided with a cut out area 56 such that the potential customer can view the contents of the container.

Turning now to FIG. 4, a depiction of preformed container 130 is shown. The preformed container 130 provides direct packaging contact with the raw dough or dough intermediate 140 and is chose for such direct food packaging. The preformed container may be a bag as shown in FIG. 4 that contains a plurality of raw dough pieces or intermediate or as illustrated in FIG. 4A an envelope or sleeve 131 that has only a couple of dough intermediates or raw dough pieces 140. Each of the preformed containers 130 and 131 after filling are closed through use of a seam 142 or other closure means such as a clip, weld or the like. The bag, envelope or sleeve may be constructed from a polyester based material or other plastic or synthetic substances although other films are also suitable. The film should be sufficiently flexible to allow for some expansion of the contents due to the gas released by the raw dough or dough intermediates. Alternatively, the bag could be provided with a coating that scavenges the gas or a sachet which sequesters the gas to reduce the amount of internal pressure. In addition, the preformed container can also be provided with a vent so as to enable gas to escape from the interior of the container.

While FIGS. 4 and 4A illustrate bags, envelopes or sleeves, it should be understood that other preformed containers are also suitable for use with the present invention. These include, but are not limited to tubes, cans and other structures each of which should be sized and configured so as to fit within the generally quadrate container 10. The tube or cans may be made of film, plastic material as described above or coated paperboard. Generally, the second or additional containers that fit within the quadrate container 10 are constructed of a material that is distinct from the quadrate container 10, for the purposes of this section, paperboard and coated paperboard are distinct materials.

In certain embodiments, preformed container(s) 130, 131 (if provided) will be a pouch that holds two biscuits or other products. In an exemplary embodiment of the present invention the package will have 4 pouches, each of the pouches 130 containing two biscuits, creating an eight-pack product (four pouches, each with two dough intermediates for a total of 8 dough intermediates in the quadrate container 10). The intent in providing such an arrangement is “portion control” for the consumer. That is, the consumer can use two biscuits while the remaining biscuits remain sealed in their original packaging, preserving the product for use at a later time. Obviously, there can be any number of preformed packages 130 contained within the container 10 or any number of dough intermediates provided within the preformed packages 130 of the present invention.

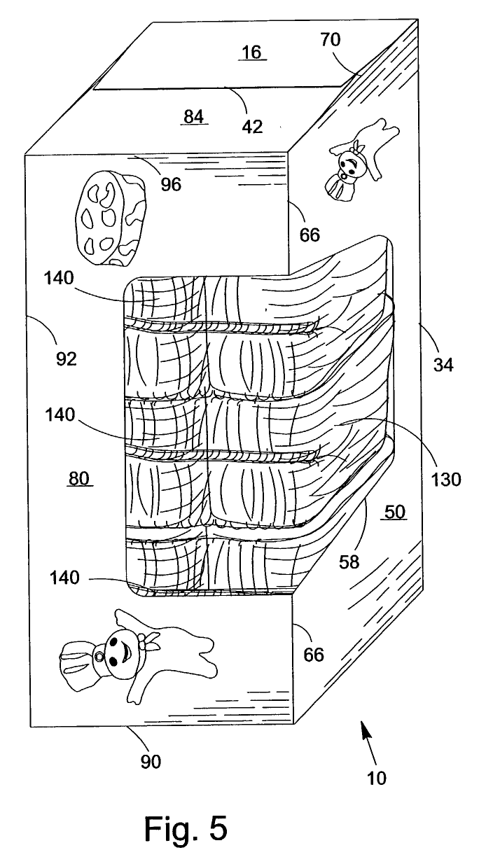

FIG. 5 is provided for its depiction of the generally quadrate container 10 having one or more preformed containers 130 contained therein. FIG. 6 provides an alternate view of the generally quadrate container 10 without the cutout 56.

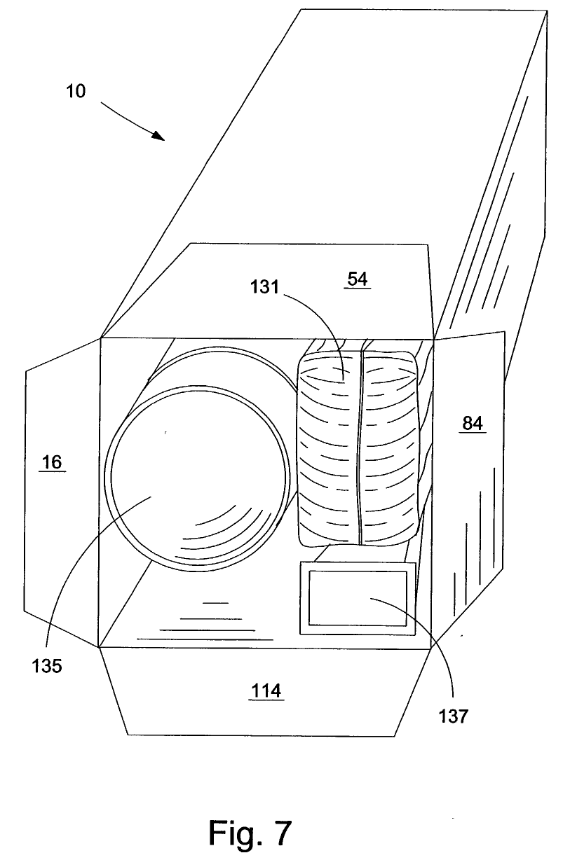

FIG. 7 provides a side view of the generally quadrate container 10 having the end flaps 16, 84 and 54 open to display more than one-preformed containers 131, 135 and 137. In this representative example, it will be seen that there is an envelope 131, a dough can 135 and a sauce, spread or dip container 137 provided along with the contents. This embodiment not only illustrates that different containers can be used with the present invention but also that the multiple types of internal containers can be inserted into the generally quadrate container 10 of the present invention.

The generally quadrate container may also be provided with an external overwrap (not shown) as part of the packaging arrangement and of course may take forms other than generally quadrate, such as triangular. In any event, the container should be sufficiently large (have a sufficiently large interior volume) so as to be able to hold one or more internal raw dough preformed containers.

The illustrations of FIGS. 5 and 7 show other embodiments of the present invention. That is, there can be a single or second dough intermediate container contained within the quadrate container 10, or there can be multiple additional containers provided within the quadrate container 10 which provides the external or protective container. The second, third and possibly other containers may either all have the same size, or internal volume such as if each was packed with biscuits, rolls, buns, breadsticks or the like or the internal containers can each be of a different dimension or size or internal volume. However, the internal volume of the second and any additional containers are distinct from the internal volume of the first container. In addition, the external or first container is usually constructed of a different material such as a paperboard and the second, third or any additional containers (if any) maybe constructed of a material distinct from the first container. That is, the second or additional containers could be plastic or coated paperboard and the first container uncoated paperboard.

In order to further illustrate the multiple package arrangement of the present invention one of the interior containers or second containers could contain rolls or biscuits and another container could hold breadsticks or dough for producing a loaf of bread, thus providing something of a complete meal concept. Alternatively, one or more of the additional containers could be used for dips, spreads, sauces and combinations thereof (see FIG. 7) to provide further satisfaction for the consumer.

It will thus be seen according to the present invention a highly advantageous multiple part package for refrigerated and frozen dough intermediates or raw dough has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

1. A quadrate container for refrigerated and frozen doughs, comprising;
a generally planar element for enclosing a packaged dough intermediate, said generally planar element having first and second side edges and first and second ends, said first and second ends being substantially parallel to one another and substantially perpendicular to said first and second sides, and said generally planar element having first and second faces;
said generally planar element having at least first, second and third lines of weakness disposed in said generally planar element and substantially parallel to said first and second sides;
first and second fold lines formed in said generally planar element extending longitudinally of said generally planar element and running generally parallel to one another and spaced from said first and second ends;
a sealing flap provided adjacent one of said first and second sides and substantially parallel to said one of said first and second sides for holding said generally planar element in a folded configuration;
first, second, third and fourth panels disposed between said first and second sides, said first panel defined between one of said first and second sides and said first line of weakness, said second panel defined between said first line of weakness and said second line of weakness, said third panel defined between said second line of weakness and said third line of weakness and said fourth panel defined between said third line of weakness and one of said first and second sides; and
at least one preformed container sized and configured to hold said dough intermediate and sized and configured to fit within said generally planar element when in said folded configuration to provide a portion controlled container for refrigerated and frozen doughs.

2. A quadrate container for refrigerated and frozen doughs as recited in claim 1, wherein said generally planar element is constructed of paperboard.

3. A quadrate container for refrigerated and frozen doughs as recited in claim 1, wherein at least one of said first, second, third and fourth panels is provided with a cut out area to enable viewing of said preformed container when said generally planar element is in its folded configuration.

4. A quadrate container for refrigerated and frozen doughs as recited in claim 1, wherein said sealing flap is provided with a line of adhesive to close said generally planar element in is folded configuration.

5. A quadrate container for refrigerated and frozen doughs as recited in claim 1, wherein said sealing flap is defined by one of said first and second sides and a fourth line of weakness.

6. A quadrate container for refrigerated and frozen doughs as recited in claim 1, wherein said preformed container is an envelope.

7. A quadrate container for refrigerated and frozen doughs as recited in claim 6, wherein said envelope is constructed of a plastic film.

8. A quadrate container for refrigerated and frozen doughs as recited in claim 1, wherein said preformed container is a dough can.

9. A quadrate container for refrigerated and frozen doughs as recited in claim 1, wherein said preformed container is a tube.

10. A quadrate container for refrigerated and frozen doughs as recited in claim 1, wherein said preformed container is a sleeve.

11. A quadrate container for refrigerated and frozen doughs as recited in claim 1, wherein a second preformed container is provided within said generally planar element when in its folded configuration.

12. A quadrate container for refrigerated and frozen doughs as recited in claim 11, wherein said second preformed container is a container for sauces, spreads, dips and combinations thereof.

13. A multiple part container for use with refrigerated and frozen dough, comprising;
a first container having a first internal volume and constructed of a first material;
at least a second container having a second internal volume and constructed of a second material distinct from said-first material, said second internal volume being less than said first internal volume and said second container sized and configured to fit within said first container; and
wherein said second container is sized and configured to receive at least one dough intermediate to create a portion controlled container for refrigerated and frozen doughs.

14. A multiple part container for use with refrigerated and frozen dough as recited in claim 13, wherein said first material is paperboard.

15. A multiple part container for use with refrigerated and frozen dough as recited in claim 13, wherein said second material is a plastic film.

16. A multiple part container for use with refrigerated and frozen dough as recited in claim 13, wherein said plural part container includes a third container having a third internal volume and constructed of a third material.

17. A multiple part container for use with refrigerated and frozen dough as recited in claim 16, wherein said third container is equivalent in size and configuration to said second container.

18. A multiple part container for use with refrigerated and frozen dough as recited in claim 16, wherein said third internal volume is distinct from each of said first and second internal volumes.

19. A multiple part container for use with refrigerated and frozen dough as recited in claim 16, wherein said third container is provided with a dip, spread, sauce or combinations thereof.

20. A multiple part container for use with refrigerated and frozen dough as recited in claim 13, wherein said second container is a dough can.

21. A multiple part container for use with refrigerated and frozen dough as recited in claim 20, wherein said dough can is constructed of a coated paperboard material.
